(19) United States
(12) Patent Application Publication
(10) Pub. No.: US 2007/0260681 A1
(43) Pub. Date: Nov. 8, 2007

(54) System and Method for Generating Communication History for a Plurality of Participants

(76) Inventors: Michal Jacovi, Rakefet (IL); Boaz Mizrachi, Haifa (IL); Mark Richard Palmer, Coppell, TX (US); Viadimir Soroka, Karmiel (IL)

Correspondence Address: IBM CORPORATION, T.J. WATSON RESEARCH CENTER, P.O. BOX 218, YORKTOWN HEIGHTS, NY, 10598, US

(21) Appl. No.: 11/381,132

(22) Filed: May 2, 2006

(51) Int. Cl. G06F 15/16

(52) U.S. Cl. 709/204

(57) ABSTRACT

System and method for generating a communication history for a plurality of participants corresponding to one or more collaborative systems are disclosed. The method includes searching a collector-database for one or more communication instances corresponding to the plurality of participants in one or more collaborative systems. The collector-database stores information corresponding to each communication instance for one or more collaborative systems. Thereafter, one or more communication instances are collated corresponding to one or more collaborative systems to form collated communication instances. The collated communication instances are collated for the plurality of participants. The method further includes, presenting the collated communication instances corresponding to one or more collaborative system as the communication history for the plurality of participants.

### FIELD OF THE INVENTION

The present invention generally relates to the field of communication. More specifically, the invention relates to generating communication history for a plurality of participants.

### BACKGROUND OF THE INVENTION

There exist a number of collaborative systems that enable communication and collaboration between users on computer systems. Example of collaborative systems may include, but arc not limited to, instant messenger for chatting, e-mail application, web-forums, and Voice Over Internet Protocol (VoIP) applications.

A collaborative system is used for conducting a plurality of communications. The plurality of communications may correspond to one or more topics. Each communication instance corresponding to the topic has to be viewed individually as collective viewing of each communication instance conducted by a set of participants corresponding to the topic is a cumbersome job.

Additionally, a communication corresponding to a topic may be conducted on one or more collaborative systems by a plurality of participants participating in the communication. A first set of communication instances corresponding to the topic may be conducted on a an e-mail application by the plurality of participants and a second set of communication instances corresponding to the topic may be conducted on a web-forum by the plurality of participants. To view each communication instance of the communication corresponding to the topic conducted by the plurality of participants, a participant has to individually view each communication instance conducted on each collaborative system used by the participant. Each communication instance of the communication instance corresponding to the topic conducted by the plurality of participants cannot be viewed collectively.

In conventional collaborative systems, for examples, e-mail application and web-forums, communication instances for a communication corresponding to a topic are combined as a single thread. Therefore, a participant in the communication can view each communication instance corresponding to the topic by browsing the single thread.

In sonic convention applications, for example activity explorer, communication instances conducted on one or more collaborative systems by a plurality of participants are collated based on the topic of each communication instance. This is achieved by initiating all the communication instances over one or more collaborative systems using a same starting point, i.e., activity explorer User Interface (UI).

However, one or more of the above listed applications have one or more of the following limitations. The applications are limited to a single collaborative system. Further, the applications require use of a single point for initiating one or more communication instances over one or more collaborative systems, which is always not applicable and possible.

### SUMMARY OF THE INVENTION

An object of the invention is to provide a system and method for generating communication history for a plurality of participants corresponding to one or more collaborative systems.

Another object of the invention is to provide a system and method to collate one or more communication instances for the plurality of participants corresponding to one or more collaborative systems based on the contextual information of each communication instance.

The above listed objects are achieved by providing system and method for generating a communication history for a plurality of participants corresponding to one or more collaborative systems. The method comprises searching a collector-database for one or more communication instances corresponding to the plurality of participants in one or more collaborative systems. The collector-database stores information corresponding to each communication instance for one or more collaborative systems. Thereafter, one or more communication instances are collated corresponding to one or more collaborative systems to form collated communication instances. The collated communication instances are collated for the plurality of participants. The method further comprises, presenting the collated communication instances corresponding to one or more collaborative system as the communication history for the plurality of participants.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a flowchart of a method for generating a communication history for a plurality of participants, in accordance with an embodiment of the invention.

FIG. 2 is a flowchart of a method for generating a communication history for a plurality of participants, in accordance with another embodiment of the invention.

FIG. 3 is a block diagram showing components of a system for generating a communication history for a plurality of participants, in accordance with an embodiment of the invention.

FIG. 4 is a block diagram showing components of a User Interface (UI) for presenting a communication history for a plurality of participants, in accordance with an embodiment of the invention.

### DETAILED DESCRIPTION

Before describing in detail embodiments that are in accordance with the present invention, it should be observed that the embodiments reside primarily in combinations of method steps and system components related to systems and methods for generating communication history for a plurality of participants. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof arc intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process method, article, or apparatus that comprises, has, includes, contains the element. The terms “a” and “an” are defined as one or more unless explicitly stated otherwise herein. The terms “substantially”, “essentially”, “approximately”, “about” or any other version thereof arc defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Various embodiments of the invention provide system and method for generating communication history for a plurality of participants corresponding to one or more collaborative systems. Examples of one or more collaborative systems may include, but are not limited to instant messenger for chat, e-mail application, web-forums, and Voice Over Internet Protocol (VoIP) device.

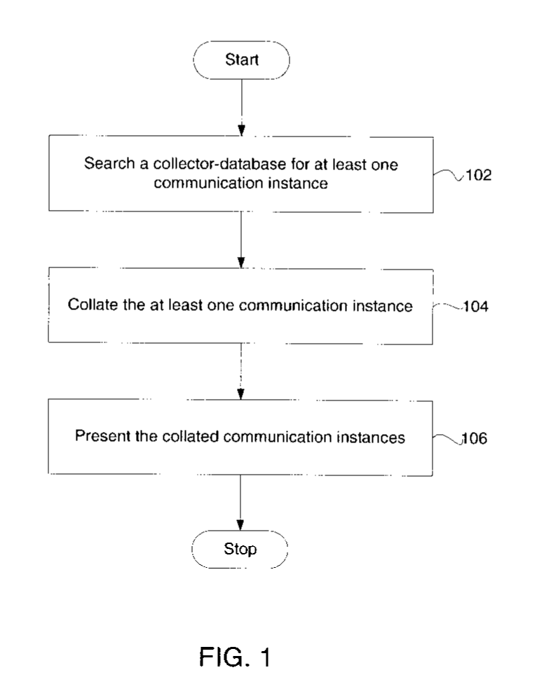

FIG. 1 is a flowchart of a method for generating a communication history for a plurality of participants, in accordance with an embodiment of the invention. The communication history is generated for the plurality of participants corresponding to one or more collaborative systems. At step 102, a collector-database is searched for one or more communication instances corresponding to the plurality of participants in one or more collaborative systems. The collector-database stores information corresponding to each communication instance for one or more collaborative systems. The information stored for each communication instance includes name of each participant in each communication instance corresponding to one or more collaborative systems. The information further includes content of each communication instance. The content of each communication instance includes communication data and the topic of communication for each communication instance. In an embodiment of the invention, the collector-database may provide a plurality of links. Each link points to content of each communication instance. Therefore, a link is used to view the content of a communication instance in a collaborative system that was used to conduct the communication instance.

For example, for a communication instance conducted in a collaborative system, such as, an instant messenger for chatting, information stored corresponding to the communication instance in the collector-database includes content of the communication instance and name of each participant in the communication instance. However, for a communication instance conducted in a collaborative system, such as, e-mail application, information stored corresponding to the communication instance includes a link to the content of the communication instance and name of each participant in the communication instance. The link can be used to view the content of the communication instance in the e-mail application.

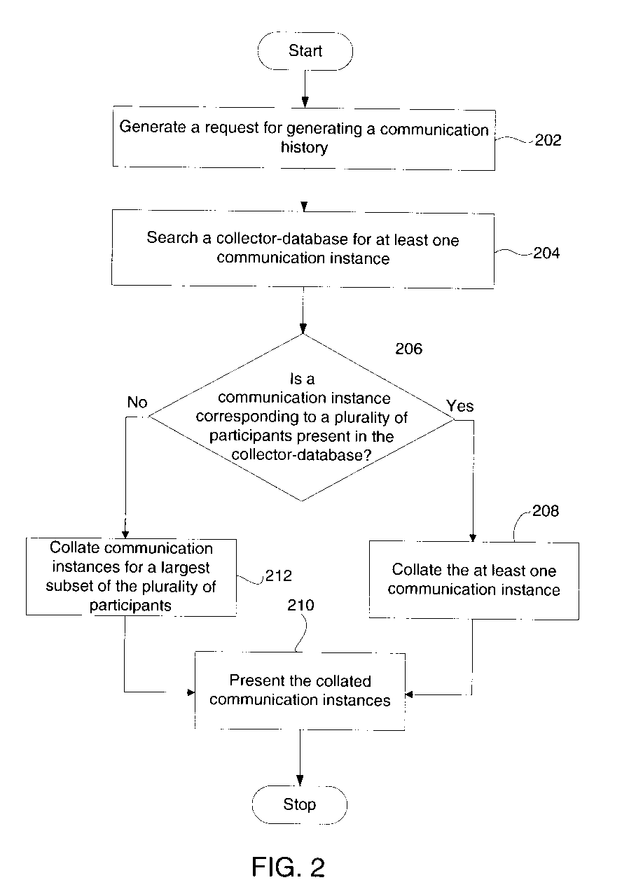

The collector-database is searched in response to a request for generating the communication history for the plurality of participants corresponding to one or more collaborative systems. This is explained in detail in conjunction with FIG. 2.

One or more communication instances, obtained by searching the collector-database, are collated at step 104. One or more communication instances are collated corresponding to one or more collaborative systems to form collated communication instances. The collated communication instances are collated for the plurality of participants. For example, a first communication instance is conducted on an e-mail application, a second communication instance is conducted on an instant messenger and a third communication instance is conducted on a web-forum. Each of the first communication instance the second communication instance and the third communication instance correspond to a first participant, a second participant, and a third participant. Therefore, the first communication instance, the second communication instance and the third communication instances are collated to form collated communication instances for the first participant, the second participant, and the third participant.

In an embodiment of the invention, the communication instances for a largest subset of the plurality of participants are collated corresponding to one or more collaborative systems, if a communication instance corresponding to the plurality of participants is absent in the collector-database. The largest subset of the plurality of participants includes one or more participants. This is explained in detail in conjunction with FIG. 2.

The collated communication instances are collated based on the contextual information of one or more communication instances corresponding to the plurality of participants. The contextual information of a communication instance corresponds to the topic of communication of the communication instance. For example, the context of communication for the first communication instance and the second communication instance is same. However, context of communication for the third communication instance is different than the first communication instance and the second communication instance. Therefore, the collated communication instances for the first participant, the second participant, and the third participant includes a first link and a second link. The first link is used to view the first communication instance and the second communication, and the second link is used to view the third communication.

In an exemplary embodiment of the invention, a topic is assigned to a set of communication instances based on the similarity scores between each communication instance. Therefore, for conducting similarity scores between VoIP communication instances, each VoIP communication instance is transcribed. In another exemplary embodiment of the invention, tagging is used to assign a topic to the set of communication instances.

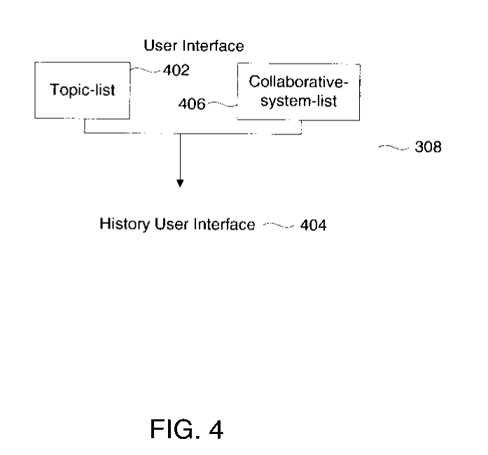

After collating one or more communication instances, the collated communication instances corresponding to one or more collaborative systems are presented as the communication history for the plurality of participants. The collated communication instances are presented as a plurality of links. Each link points to one or more communication instances corresponding to the plurality of participants for one or more collaborative systems. This is further explained in detail in conjunction with FIG. 4.

Each link can be used to view content of one or more communication instance. In an embodiment of the invention, a content of a communication instance is viewed in a proprietary window. For example, if a communication instance is conducted on an e-mail application, then clicking on a link will open a default e-mail-application window displaying the content of the communication instance. Similarly, if a communication instance is conducted on a web forum then clicking on a link will open a web-browser window displaying the content of the communication instance.

In another embodiment of the invention a content of a communication instance is viewed in a collaborative system. The communication instance corresponds to the collaborative system, i.e., the communication instance is conducted in the collaborative system. For example, if a communication instance is conducted on an e-mail application, then clicking on a link corresponding to the communication instance will open the email-application displaying the content of the communication instance.

FIG. 2 is a flowchart of a method for generating a communication history for a plurality of participants, in accordance with another embodiment of the invention. At step 202, a request is generated for generating the communication history for the plurality of participants corresponding to one or more collaborative systems. In response to the request generated for generating the communication history, the collector-database is searched for one or more communication instances, at step 204. This has been explained in detail in conjunction with FIG. 1. At step 206, a check is performed to determine if a communication instance corresponding to the plurality of participants is present in the collector-database. If a communication instance corresponding to the plurality of participants is present in the collector-database, then one or more communication instances are collated corresponding to one or more collaborative systems to form collated communication instances, at step 208. This has been explained in detail in conjunction with FIG. 1.

Thereafter, at step 210, the collated communication instances are presented as a plurality of links. This has been explained in conjunction with FIG. 1.

Referring back to step 206, if a communication instance corresponding to the plurality of participants is absent in the collector-database, then the communication instances for a largest subset of the plurality of participants are collated corresponding to one or more collaborative systems at step 212. The largest subset of the plurality of participants includes one or more participants. For example, the collector database is searched for one or more communication instances corresponding to each of the first participant, the second participant, and the third participant. Further, the collector-database includes one or more communication instances in the collector-database that corresponds to each of the first participant, and the second participant. Additionally, there is no communication instance corresponding to the third participant. Therefore, communication instances are collated for the first participant and the second participant. In an embodiment of the invention, if a communication instance corresponding to the plurality of participants is absent in the collector-database then the communication instances are not collated.

Thereafter, at step 210, the collated communication instances are presented as a plurality of links. This has been explained in conjunction with FIG. 1.

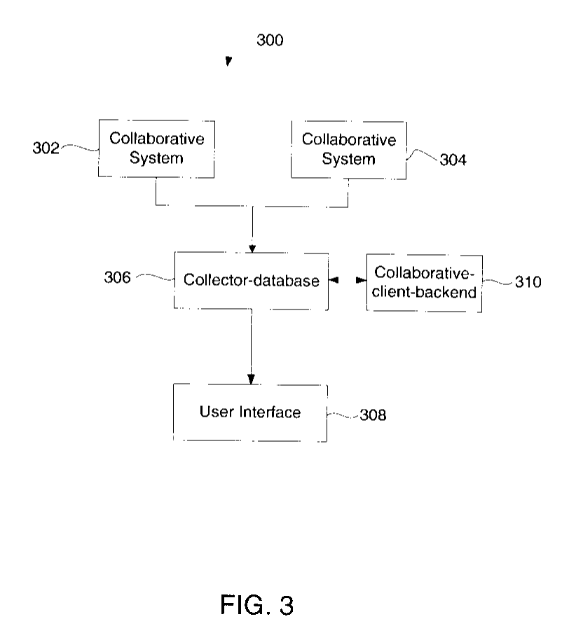

FIG. 3 is a block diagram showing components of a system 300 for generating a communication history for a plurality of participants, in accordance with an embodiment of the invention. System 300 includes one or more collaborative systems (for example, a collaborative system 302 and a collaborative system 304), a collector-database 306, and a User Interface (UI) 308. One or more collaborative systems are used for communication by the plurality of participants. Therefore, the communication history is generated corresponding to one or more collaborative systems. Collector-database 306 is associated with each collaborative system to store information for each communication instance corresponding to one or more collaborative systems. Collector-database 306 integrates a plugin for associating with a corresponding collaborative system. For example, collector-database 306 integrates an c-mail-application-plugin for associating with collaborative system 302, which is an e-mail application. Each plugin maybe one of a software program and a hardware device. In an embodiment of the invention, a collaborative-client-backend 310 associates one or more collaborative systems to collector-database 306. Therefore, a plugin is integrated into collector-database 306 by collaborative-client-backend 310 for each collaborative system associated with collector-database 306. Collaborative-client-backend 310 may disassociate one or more collaborative systems from collector-database 306.

The information stored for each communication instance in the collector-database 306 includes name of each participant in each communication instance corresponding to one or more collaborative systems. The information further includes one of a content of each communication instance and a link to a content of each communication instance. This has been explained in detail in conjunction with FIG. 1.

In an embodiment of the invention, the information for a communication instance is stored on a storage system of an electronic device. Examples of the electronic device may include, but are not limited to Personal Digital Assistant (PDA), personal computers, and laptops. The electronic device integrates a collaborative system, which is used to conduct the communication instance. For example, a communication instance is conducted on collaborative system 302 that is an instant messenger for chatting. The communication instance is stored on an electronic device that integrates the instant messenger for chatting.

In another embodiment of the invention, the information for each communication instance is stored on a server. Therefore, a remote electronic device can access the information. Each communication instance may be routed through the server for storing information for each communication instance. For example, a communication instance conducted on an e-mail application is routed though a server. Therefore, the information for the communication instance is stored on the server. In an embodiment of the invention, for a peer-peer communication each communication instance is stored on the server by a plug-in corresponding to at least one collaborative system participating in the peer-peer communication.

In another embodiment of the invention, the information for a communication instance is stored on each of a storage system of an electronic device and a server. The electronic device integrates a collaborative system, which is used to conduct the communication instance.

Further, one or more communication instances corresponding to one or more collaborative systems are collated for the plurality of participants. One or more communication instances are collated to form the communication history for the plurality of participants. UI 308 is used to display the communication history. UI 308 displays a plurality of links corresponding to each communication instance. This is further explained in conjunction with FIG. 4. Content of a communication instance can be displayed by clicking on a link corresponding to the communication instance. This has been explained in conjunction with FIG. 1.

FIG. 4 is a block diagram showing components of UI 308 for presenting a communication history for a plurality of participants, in accordance with an embodiment of the invention. UI 308 is configured to display a topic-list 402. Topic-list 402 includes a list of a plurality of topics for one or more communication instances corresponding to the plurality of participants. Each topic corresponds to the contextual information of one or more communication instances. One or more communication instances are collated by a history user interface (UI) 404 based on the contextual information of each communication instance corresponding to the plurality of participants. This has been explained in conjunction with FIG. 1. History UI 404 can be integrated with each collaborative system.

The plurality of topics are displayed as a plurality of links. The plurality of links point to the collated communication instances. For example, a first topic is displayed as a first link. Therefore, the first link can be used to view a first collated communication instance. The first collated communication instance includes one or more communication instances that have contextual information corresponding to the first topic. The collated communication instances are displayed as the communication history for the plurality of participants on UI 308.

The content of one or more communication instance for each collated communication instance is viewed in UI 308 by clicking on a link from topic-list 402. The link corresponds to the contextual information of the one or more communication instances. This has been explained in conjunction with FIG. 1

In an embodiment of the invention, content of one or more communication instances for each collated communication instance is viewed in a collaborative system corresponding to each communication instance by clicking on a link from topic-list 402. The link corresponds to the contextual information of the one or more communication instances. This has been explained in conjunction with FIG. 1.

UI 308 is further configured to present a collaborative-system-list 406. Collaborative-system-list 406 includes a plurality of set of collaborative systems. Each set of collaborative systems corresponds to a collated communication instance. For example, the first collated communication instance includes a first communication instance conducted on an e-mail application a second communication instance conducted on instant messenger, and a third communication instance conducted on a web forum. Therefore, a first set of collaborative systems corresponding to the first communication instance is presented on UI 308. The first set of collaborative systems includes an icon for each of the e-mail application, instant messenger, and web forum.

In an embodiment of the invention, UI 308 may include a list of dates and a list of time corresponding to each communication instance for each collated communication instance.

Various embodiments of the invention provide systems and method for generating communication history for a plurality of participants corresponding to one or more collaborative systems. One or more communication instances are collated based on the contextual information of each communication instance to form collated communication instance. The collated communication instances are displayed as the communication history for the plurality of participants. Therefore, communication instance corresponding to one or more collaborative systems that have same contextual information can be viewed together.

In the foregoing specification, specific embodiments of the present invention have been described. However, one of ordinary skill in the art appreciates that various modifications and changes can be made without departing from the scope of the present invention as set forth in the claims below. Accordingly, the specification and figures arc to be regarded in an illustrative rather than a restrictive sense, and all such modifications are intended to be included within the scope of present invention. The benefits, advantages, solutions to problems, and any clement(s) that may cause any benefit, advantage, or solution to occur or become more pronounced are not to be construed as a critical, required, or essential features or elements of any or all the claims.

What is claimed is:

1. A method for generating a communication history for a plurality of participants corresponding to at least one collaborative system, the method comprising:
searching a collector-database for at least one communication instance corresponding to the plurality of participants in the at least one collaborative system, wherein the collector-database stores information corresponding to each communication instance for the at least one collaborative system:
collating the at least one communication instance corresponding to the at least one collaborative system to form collated communication instances, wherein the collated communication instances are collated for the plurality of participants; and
presenting the collated communication instances corresponding to the at least one collaborative system as the communication history for the plurality of participants.

2. The method of claim 1 further comprising generating a request for generating communication history for the plurality of participants corresponding to at least one collaborative systems.

3. The method of claim 1, wherein the collated communication instances are collated based on contextual information of the at least one communication instance corresponding to the plurality of participants.

4. The method of claim 1, wherein the communication instances for a largest subset of the plurality of participants is collated corresponding to the at least one collaborative system, if a communication instance corresponding to the plurality of participants is absent in the collector-database, wherein the largest subset of the plurality of participants comprise at least one participant.

5. The method of claim 1, wherein the collated communication instances are presented as a plurality of links, each link points to at least one communication instance corresponding to the plurality of participants for the at least one collaborative system.

6. The method of claim 5, wherein a content of at least one communication instances is viewed in a proprietary window.

7. The method of claim 5, wherein a content of at least one communication instance is viewed in a collaborative system, the communication instance corresponds to the collaborative system.

8. The method of claim 1, wherein the information stored for each communication instance comprises:
name of each participant in each communication instance corresponding to the at least one collaborative system; and
a content of each communication instance.

9. The method of claim 8, further comprising a plurality of links, wherein each link points to a content of a communication instance.

10. A system for generating a communication history for a plurality of participants corresponding to at least one collaborative system:
at least one collaborative system, wherein the at least one collaborative system is used for communication by the plurality of participants;
a collector-database, wherein the collector-database stores information corresponding to each communication instance for the at least one collaborative system; and
a user interface, wherein the user interface is used to display the communication history, wherein the communication history comprises collated communication instances, wherein at least one communication instance corresponding to at least collaborative system is collated for the plurality of participants to form the collated communication instance.

11. The system of claim 10, wherein the information stored in the collector-database comprises:
a name of each participant in each communication instance corresponding to the at least one collaborative system; and
one of a link to a content of each communication instance and the content of each communication instance.

12. The system of claim 10, wherein the user interface displays a plurality of links corresponding to each communication instance.

13. The system of claim 12, wherein clicking a link corresponding to a communication instance displays content of the communication instance.

14. The system of claim 10 further comprising collaborative-client-backend, wherein the collaborative-client-backend associates at least one collaborative system to the collector-database.

15. The system of claim 14, wherein the collaborative-client-backend disassociates at least one collaborative system from the collector-database.

16. A User Interface (UI) for presenting the communication history for a plurality of participants, the UI is configured to:
display a topic-list, wherein the topic-list comprises a list of a plurality of topics for the at least one communication instance corresponding to the plurality of participants, the plurality of topics are displayed as a plurality of links, wherein the plurality of links point to collated communication instances, the collated communication instances are displayed as the communication history for the plurality of participants on the UI; and
present a collaborative-system-list, wherein the collaborative-system-list comprises a plurality of set of collaborative systems, each set of collaborative systems corresponds to a collated communication instance.

17. The UI of claim 16 is further comprises a History User Interface (History UI), the History UI is configured to:
collate the at least one communication instances based on contextual information of each communication instance corresponding to the plurality of participants to form the collated communication instances.

18. The UI of claim 17, wherein content of at least one communication instance is viewed in UI by clicking on a link from the topic-list, the link corresponds to the contextual information of the at least one communication instance.

19. The UI of claim 17, wherein content of at least one communication instance is viewed in a collaborative system corresponding to each communication instance by clicking on a link from the topic-list the link corresponds to the contextual information of the at least one communication instance.
